(19) United States
(12) Patent Application Publication
(10) Pub. No.: US 2010/0051163 A1
(43) Pub. Date: Mar. 4, 2010

(54) MODULAR PLY TIRE WITH OVERLAPPING PLIES

(76) Inventors: Robert Anthony Neubauer, Medina, OH (US); Keith Carl Trares, Akron, OH (US)

Correspondence Address: Emerson, Thomson & Bennett, LLC, 777 W. Market Street, Akron, OH, 44303, US

(21) Appl. No.: 12/201,040

(22) Filed: Aug. 29, 2008

(51) Int. Cl. B60C 9/02

(52) U.S. Cl. 152/548

(57) ABSTRACT

A tire carcass is disclosed herein which includes a first radial ply with a shoulder portion and a lateral edge portion, the lateral edge portion being wrapped around a bead core, a carcass crown portion, the carcass crown portion having a first edge and a second edge, and a second radial ply with a second shoulder portion and a second lateral edge, the second lateral edge portion being wrapped around a second bead core, the first radial ply extending beyond the first edge of the carcass crown portion and the second radial ply extending beyond the second edge of the carcass crown portion.

### I. BACKGROUND OF THE INVENTION

A. Field of Invention

This invention pertains to the art of methods and apparatuses regarding tires, and more particularly to methods and apparatuses regarding two ply tires, and even more particularly to methods and apparatuses regarding modular ply tires with overlapping plies in the crown area.

B. Description of the Related Art

U.S. Pat. No. 6,913,052 discloses a tire construction and method of building a tire which includes the steps of cylindrically applying a pair of radial cord reinforced sidewall plies, fixing the axial spacing between the bead cores; applying a crown ply, turning up each sidewall ply to overlap lateral edges of the crown ply; moving the carcass assembly axially inwardly while shaping the carcass assembly toroidially to form ply turnups axially inwardly of the bead cores. The method further comprises the steps of applying one or more belt reinforcing layers to the carcass and first reinforcing layer and applying a tread to form a pneumatic radial ply tread tire.

U.S. Pat. No. 6,883,570 discloses a tire comprising at least one reinforcement structure of carcass type anchored on each side of the tire in a bead, a crown reinforcement, each bead being extended radially towards the outside by a sidewall, said reinforcement structure being discontinuous over at least a portion of the crown of the tire, said crown reinforcement comprising on the one hand at least one primary reinforcement structure covering substantially the entire width of the crown and comprising on the one hand, on each side of the tire, a lateral primary reinforcement structure portion disposed radially outside the adjacent carcass-type reinforcement structure portion and on the other hand a median primary reinforcement structure portion disposed radially more to the inside than the lateral primary reinforcement structure portions and at least one substantially axial row of median circumferential reinforcements disposed radially to the outside, substantially adjacent the median primary reinforcement structure portion.

U.S. Pat. No. 6,883,571 discloses a tire comprising at least one reinforcement structure of carcass type anchored on each side of the tire in a bead, a crown reinforcement, sidewalls meeting up radially towards the outside with a tread, the carcass-type reinforcement structure extending circumferentially from the bead towards said sidewall and being discontinuous over at least a portion of the crown of the tire, said crown reinforcement comprising on the one hand at least one primary reinforcement structure covering substantially the entire width of the crown and on the other hand at least one series of circumferential reinforcements also covering substantially the entire width of the crown, said series of circumferential reinforcements comprising a portion of lateral circumferential reinforcements disposed radially to the outside relative to said primary reinforcement structures and a portion of median circumferential reinforcements disposed radially to the inside relative to said primary reinforcement structures.

### II. SUMMARY OF THE INVENTION

According to one embodiment of this invention, a tire carcass includes a first radial ply with a shoulder portion and a lateral edge portion, the lateral edge portion being wrapped around a bead core, a carcass crown portion, the carcass crown portion having a first edge and a second edge, and a second radial ply with a second shoulder portion and a second lateral edge, the second lateral edge portion being wrapped around a second bead core, the first radial ply extending beyond the first edge of the carcass crown portion and the second radial ply extending beyond the second edge of the carcass crown portion.

According to another embodiment of this invention, the first radial ply and second radial ply extend beyond the edges of the carcass crown portion such that the plies overlap each other.

According to another embodiment of this invention, the first radial ply extends to the second edge and the second radial ply extends to the first edge.

According to another embodiment of this invention, the carcass has a center line perpendicular to the bead core, wherein the first radial ply is at an angle of less than approximately 85° with respect to the center line, and the second radial ply is at an angle of less than approximately 85° with respect to the center line.

According to another embodiment of this invention, the first radial ply is at an angle of less than approximately −85° with respect to the center line, and the second radial ply is at an angle less than approximately −85° with respect to the center line.

According to another embodiment of this invention, a pneumatic tire includes a carcass, a first radial ply with a shoulder portion and a lateral edge portion, the lateral edge portion being wrapped around a bead core, sidewalls, a carcass crown portion, the carcass crown portion having a first edge and a second edge, and a second radial ply with a second shoulder portion and a second lateral edge portion, the second lateral edge portion being wrapped around a second bead core, the first radial ply extending beyond the first edge of the carcass crown portion and the second radial ply extending beyond the second edge of the carcass crown portion.

According to another embodiment of this invention, a tire carcass includes at least a first radial ply with a shoulder portion and a lateral edge portion, the lateral edge portion being wrapped around a bead core, a carcass crown portion, the carcass crown portion having a first edge and a second edge, and at least a second radial ply with a second shoulder portion and a second lateral edge, the second lateral edge portion being wrapped around a second bead core, the at least a first radial ply extending beyond the first edge of the carcass crown portion and the at least a second radial ply extending beyond the second edge of the carcass crown portion.

One advantage of this invention is that allowing two plies to be in the crown portion of the tire provides increased puncture resistance and a two ply crown construction.

Another advantage of this invention is that angling the plies at angles less than 85° provides tunability of the tire.

Another advantage is the consolidation of three plies, by eliminating a centerply, into two plies provides the tire with lower weight via reduced material use, and lower costs.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a cross-section of the ply section of a tire showing the overlapping ply construction; and,

FIG. 2 is a cross-section of the ply-section of a tire, showing belts and the overlapping ply construction.

### IV. DEFINITIONS

The following terms may be used throughout the descriptions presented herein and should generally be given the following meaning unless contradicted or elaborated upon by other descriptions set forth herein.

“Axial” and “axially” mean the lines or directions that are parallel to the axis of rotation of the tire.

“Carcass” means the tire structure apart from the belt structure, tread, undertread, and sidewall rubber over the plies, but including bead cores.

“Carcass crown portion” means the portion of the carcass over which the crown is placed.

“Crown” or “tire crown” means the tread, tread shoulders, and the immediately adjacent portions of the sidewalls.

“Interior” means, generally, the inside surface of the tire.

“Exterior” means, generally, the outside surface of the tire.

“Pneumatic tire” means a laminated mechanical device of generally toroidal shape (usually an open-torus) having bead cores and a tread and made of rubber, chemicals, fabric and steel or other materials. When mounted on the wheel of a motor vehicle, the tire through its tread provides traction and contains the fluid that sustains the vehicle load.

“Radial” and “radially” mean directions toward or away from the axis of rotation of the tire.

“Sidewall” means that component which comprises a portion of the outside surface of a tire between the tread and the bead.

### V. DETAILED DESCRIPTION OF THE INVENTION

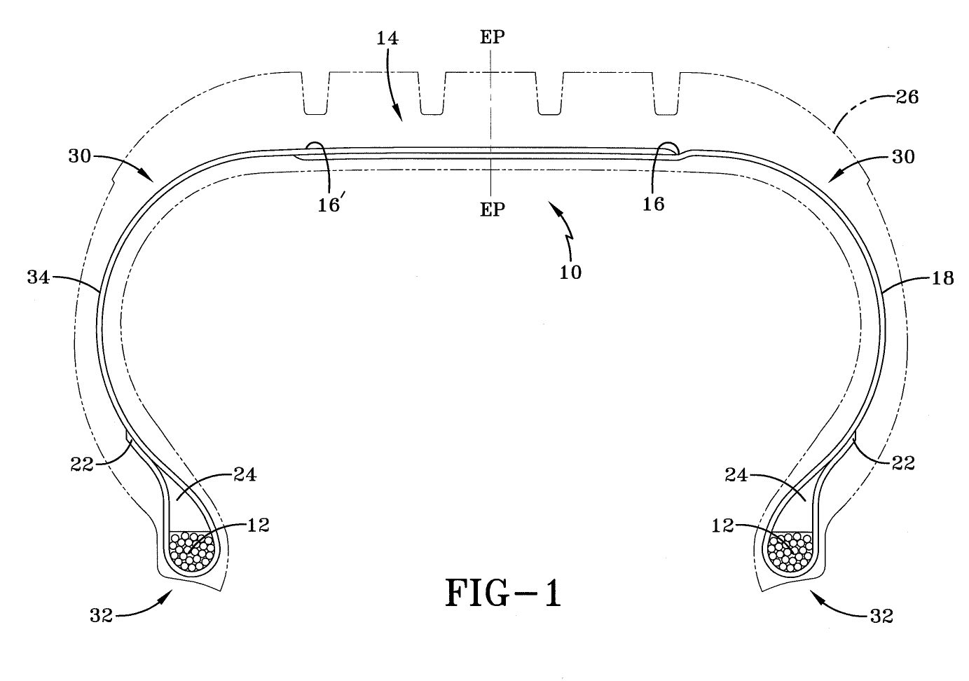

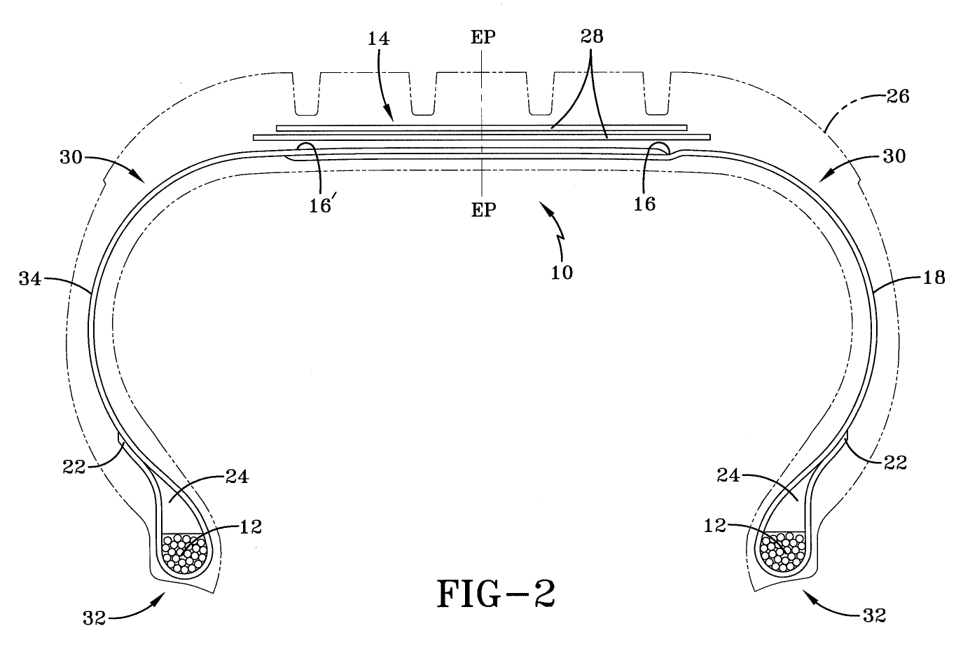

Referring now to the drawings wherein the showings are for purposes of illustrating embodiments of the invention only and not for purposes of limiting the same, FIG. 1 shows a tire carcass 10, having two beads 12, a carcass crown portion 14 (wherein the carcass crown portion 14 has a first edge 16 and a second edge 16′), a first radial ply 18, a second radial ply 34, turn-up ends 22, apexes 24, shoulders 30, 30′ and bead regions 32. The bead regions 32 have a pair of axially spaced beads 12 around which are wrapped turn-up ends 22. The apexes 24 are sandwiched between the main body of the carcass 10 and the turn-up ends 22. The carcass 10 is surrounded by tread 26. In FIG. 2, the carcass 10 is shown with belts 28 overlaying the carcass crown portion 14.

With continuing reference to FIGS. 1 and 2, the first radial ply 18, in this embodiment, extends to the second edge 16′ and the second radial ply 34 extends to the first edge 16, such that the first radial ply 18 and the second radial ply 34 overlap. It is to be understood that the invention does require the plies 18, 34 to extend to the edges 16, 16′, but only that the plies 18, 34 overlap. This allows the elimination of a center ply material.

With continuing reference now to FIGS. 1 and 2, the different plies 18, 34 can be made of different material, which provides tunability for the tire. In this embodiment, the plies 18, 34 are at an angle of less than approximately 85°, with respect to a centerline running parallel to the cross-section. This angling of the plies 18, 34 also allows for tunability of the tire. The plies 18, 34 can be angled in the same direction, or can be angled in different directions. The centerline is perpendicular to the bead core. It is to be understood that the angling of the plies 18, 34 is merely one embodiment of the invention, and is not intended to limit the invention in any manner.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A tire carcass comprising:
a first radial ply with a shoulder portion and a lateral edge portion, the lateral edge portion being wrapped around a bead core;
a carcass crown portion, the carcass crown portion having a first edge and a second edge; and,
a second radial ply with a second shoulder portion and a second lateral edge, the second lateral edge portion being wrapped around a second bead core, the first radial ply extending beyond the first edge of the carcass crown portion and the second radial ply extending beyond the second edge of the carcass crown portion.

2. The tire carcass of claim 1, wherein the first radial ply and second radial ply extend beyond the edges of the carcass crown portion such that the plies overlap each other.

3. The tire carcass of claim 2, wherein the first radial ply extends to the second edge and the second radial ply extends to the first edge.

4. The tire carcass of claim 1, wherein the carcass has a center line perpendicular to the bead core, wherein the first radial ply is at an angle of less than approximately 85° with respect to the center line, and the second radial ply is at an angle of less than approximately 85° with respect to the center line.

5. The tire carcass of claim 1, wherein the first radial ply is at an angle of less than approximately −85° with respect to the center line, and the second radial ply is at an angle less than approximately −85° with respect to the center line.

6. The tire carcass of claim 3, wherein the carcass has a center line perpendicular to the bead core, wherein the first radial ply is at an angle of less than approximately 85° with respect to the center line, and the second radial ply is at an angle of less than approximately 85° with respect to the center line.

7. The tire carcass of claim 6, wherein the first radial ply is at an angle of less than approximately −85° with respect to the center line, and the second radial ply is at an angle less than approximately −85° with respect to the center line.

8. The tire carcass of claim 4, wherein the first radial ply is at an angle of between approximately 75° and approximately 85° with respect to the center line, and the second radial ply is at an angle of between approximately 75° and approximately 85° with respect to the center line.

9. The tire carcass of claim 5, wherein the first radial ply is at an angle of between approximately −75° and approximately −85° with respect to the center line, and the second radial ply is at an angle of between approximately −75° and approximately −85° with respect to the center line.

10. A pneumatic tire comprising:
a carcass;
a first radial ply with a shoulder portion and a lateral edge portion, the lateral edge portion being wrapped around a bead core;
sidewalls;
a carcass crown portion, the carcass crown portion having a first edge and a second edge; and,
a second radial ply with a second shoulder portion and a second lateral edge portion, the second lateral edge portion being wrapped around a second bead core, the first radial ply extending beyond the first edge of the carcass crown portion and the second radial ply extending beyond the second edge of the carcass crown portion.

11. The tire of claim 10, wherein the first radial ply and second radial ply extend beyond the edges of the carcass crown portion such that the plies overlap each other.

12. The tire of claim 11, wherein the first radial ply extends to the second edge and the second radial ply extends to the first edge.

13. The tire of claim 10, wherein the carcass has a center line perpendicular to the bead core, wherein the first radial ply is at an angle of less than approximately 85° with respect to the center line, and the second radial ply is at an angle of less than approximately 85° with respect to the center line.

14. The tire of claim 10, wherein the first radial ply is at an angle of less than approximately −85° with respect to the center line, and the second radial ply is at an angle less than approximately −85° with respect to the center line.

15. The tire of claim 12, wherein the carcass has a center line perpendicular to the bead core, wherein the first radial ply is at an angle of less than approximately 85° with respect to the center line, and the second radial ply is at an angle of less than approximately 85° with respect to the center line.

16. The tire of claim 15, wherein the first radial ply is at an angle of less than approximately −85° with respect to the center line, and the second radial ply is at an angle less than approximately −85° with respect to the center line.

17. A tire carcass comprising:
at least a first radial ply with a shoulder portion and a lateral edge portion, the lateral edge portion being wrapped around a bead core;
a carcass crown portion, the carcass crown portion having a first edge and a second edge; and,
at least a second radial ply with a second shoulder portion and a second lateral edge, the second lateral edge portion being wrapped around a second bead core, the at least a first radial ply extending beyond the first edge of the carcass crown portion and the at least a second radial ply extending beyond the second edge of the carcass crown portion.

18. The tire carcass of claim 17, wherein the at least a first radial ply and the at least a second radial ply extend beyond the edges of the carcass crown portion such that the plies overlap each other.

19. The tire carcass of claim 17, wherein the carcass has a center line perpendicular to the bead core, wherein the at least a first radial ply is at an angle of less than approximately 85° with respect to the center line, and the at least a second radial ply is at an angle of less than approximately 85° with respect to the center line.

20. The tire carcass of claim 17, wherein the at least a first radial ply is at an angle of less than approximately −85° with respect to the center line, and the at least a second radial ply is at an angle less than approximately −85° with respect to the center line.
